(19) United States
(12) Patent Application Publication
(10) Pub. No.: US 2013/0115367 A1
(43) Pub. Date: May 9, 2013

(54) METHOD FOR FORMING RUTHENIUM OXIDE FILM

(71) Applicant: Tokyo Electron Limited, Tokyo (JP)

(72) Inventors: Naotaka NORO, Yamanashi (JP); Hiroaki ASHIZAWA, Yamanashi (JP); Junya HARA, Yamanashi (JP); Takaaki IWAI, Yamanashi (JP)

(73) Assignee: TOKYO ELECTRON LIMITED, Tokyo (JP)

(21) Appl. No.: 13/661,514

(22) Filed: Oct. 26, 2012

(30) Foreign Application Priority Data
Nov. 4, 2011 (JP) 2011-242630
Sep. 27, 2012 (JP) 2012-214090

(51) Int. Cl. H01B 13/00

(52) U.S. Cl. 427/79

(57) ABSTRACT

A method for forming a ruthenium oxide film includes: providing a substrate in a processing chamber; supplying a ruthenium compound having a structure of the following formula (1) in which two β-diketons and two groups selected among olefin, amine, nitril, and carbonyl are coordinate-bonded to Ru in a vapor state onto the substrate; supplying oxygen gas onto the substrate; and forming a ruthenium oxide film on the substrate by reaction between the ruthenium compound gas and the oxygen gas.

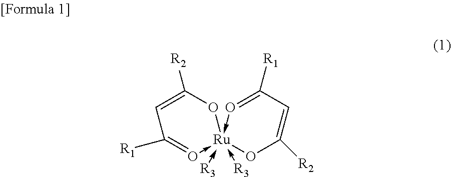

where R₁ and R₂ indicate alkyl groups having a total carbon number of about 2 to 5, and R₃ indicates a group selected among an olefin group, an amine group, a nitril group and a carbonyl group.

### CROSS-REFERENCE TO RELATED APPLICATIONS

The present application claims priority under 35 U.S.C. §119 to Japanese Patent Application Nos. 2011-242630 and 2012-214090 filed on Nov. 4, 2011 and Sep. 27, 2012, respectively. The contents of these applications are incorporated herein by reference in their entirety.

### FIELD OF THE INVENTION

The present invention relates to a method for forming a ruthenium oxide film by a chemical vapor deposition (CVD) method.

### BACKGROUND OF THE INVENTION

Recently, various high-k dielectric materials are used for a capacitor of a DRAM. Particularly, a strontium titanate film (SrTiO film) is being highlighted. Further, a ruthenium oxide film (RuOx film) is being highlighted as an electrode material of a capacitor using the SrTiO film.

In forming an electrode of a capacitor, it is required to form a film in a recess having an aspect ratio of about 50 or above and have a good step coverage. Accordingly, it is considered to form an RuOₓ film by using a CVD method that ensures a good step coverage or an ALD (Atomic Layer Deposition) method, as one of CVD methods, for alternately supplying a precursor and a reduction gas.

For example, Journal of the Electrochemical Society 147(1) pp 203 to 209 (2000) discloses a method for forming an RuOₓ film while using as a precursor Ru(CP)₂ and Ru(C₅H₅)₂. Moreover, Journal of the Electrochemical Society 147(3) pp 1161 to 1167 (2000) and Journal of the Korean Physical Society Vol. 55, No. 1 Jul. 2009 PP 32 to 37 disclose methods for forming an RuOₓ film while using as a precursor Ru(EtCP)₂ and Ru(C₅H₄—C₂H₅)₂.

In the case of forming an RuOₓ film used for an electrode of a capacitor, it is required to ensure a good step coverage, reduce an incubation time and increase a film forming rate. However, the techniques of the above-cited references do not satisfy the above three requirements.

### SUMMARY OF THE INVENTION

In view of the above, the present invention provides a method for forming a ruthenium oxide film in a recess having a high aspect ratio of about 50 or above by a CVD method while ensuring a high step coverage, a short incubation time and a high film forming rate.

In accordance with a first aspect of the present invention, there is provided a method for forming a ruthenium oxide film, including: providing a substrate in a processing chamber; supplying a ruthenium compound having a structure of the following formula (1) in which two p-diketons and two groups selected among olefin, amine, nitril, and carbonyl are coordinate-bonded to Ru in a vapor state onto the substrate; supplying oxygen gas onto the substrate; and forming a ruthenium oxide film on the substrate by reaction between the ruthenium compound gas and the oxygen gas.

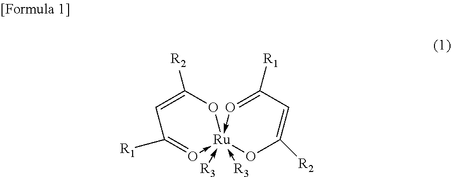

where R₁ and R₂ indicate alkyl groups having a total carbon number of about 2 to 5, and R₃ indicates a group selected among an olefin group, an amine group, a nitril group and a carbonyl group.

In accordance with a second aspect of the present invention, there is provided a storage medium that stores a program for execution on a computer to control a film forming apparatus, wherein the program, when executed, controls the film forming apparatus such that the above method is performed.

In the present invention, a ruthenium film is formed by a CVD method (including an ALD method) while using an oxygen gas as a reduction gas and a ruthenium compound having a structure of formula (1) in which two β-diketons and two groups selected among olefin, amine, nitril and carbonyl are coordinate-bonded to a ruthenium as a film forming material (precursor). Therefore, the film formation can be performed while ensuring a short incubation time and a high film forming rate. Further, a good step coverage that allows a film to be formed in a recess having a high aspect ratio of about 50 or above can be achieved. In other words, in the film forming material (precursor), the groups (ligands) such as olefin, amine, nitril, carbonyl and the like which are coordinate-bonded to Ru are difficult to prevent Ru from being adsorbed onto the substrate and comparatively easily separated. Hence, Ru is easily adsorbed onto the substrate, which results in a short incubation time. Since Ru is easily adsorbed onto the substrate, an excellent step coverage can be obtained, and a film can be formed in a recess having a high aspect ratio of about 50 or above. Moreover, other β-diketons (diketonate ligands) are easily decomposed by the oxygen gas. Thus, a ruthenium oxide film can be rapidly formed on the substrate, and a high film forming rate can be obtained.

The film forming material used in the present invention is described in U.S. Pat. Nos. 7,049,232 and 4,746,141. However, in such references, the film forming material is used only for forming a ruthenium film. The present inventors have found that a ruthenium oxide film having the above-described characteristics can be obtained by using the film forming material and oxygen gas.

In this specification, a unit of a gas flow rate is mL/min. Since, however, a volume of gas is greatly varied depending on a temperature and a pressure, a value converted to a standard state is used in the present invention. The flow rate converted to the standard state is generally indicated by sccm (Standerd Cubic Centimeter per Minutes), so that a unit of sccm is also used. Here, the standard state indicates a state (STP) in which a temperature is about 0° C. (273.15K) and a pressure is about 1 atm (101325 Pa).

### BRIEF DESCRIPTION OF THE DRAWINGS

The objects and features of the present invention will become apparent from the following description of embodiments, given in conjunction with the accompanying drawings, in which:

FIG. 1 schematically shows an example of a film forming apparatus for performing a method for forming a ruthenium oxide film in accordance with an embodiment of the present invention;

FIG. 2 is a cross sectional view for explaining an example in which a ruthenium oxide film is used as a lower electrode of a DRAM capacitor.

FIG. 3 is a cross sectional view for explaining an example in which a ruthenium oxide film is used as an upper electrode of a DRAM capacitor.

FIG. 4 is a timing diagram showing a sequence of film formation using an ALD method;

FIG. 5 is a chart showing an X-ray diffraction peak of Ru;

FIG. 6 is a chart showing an X-ray diffraction peak of RuO₂;

FIG. 7 shows X-ray diffraction spectra of films formed while varying film forming temperatures to about 250° C., 270° C., 300° C. and 320° C. under the conditions including a pressure of about 50 Torr, an O₂ gas flow rate of about 20 mL/min(sccm), an Ru compound gas flow rate of about 2.26 mL/min(sccm), an O₂ gas partial pressure of about 2.37 Torr, and an O₂/Ru compound partial pressure ratio of about 8.85;

FIG. 8 shows X-ray diffraction spectra of films formed while varying film forming temperatures to about 250° C., 270° C., 300° C. and 320° C. under the conditions including a pressure of about 50 Torr, an O₂ gas flow rate of about 50 mL/min(sccm), an Ru compound gas flow rate of about 2.26 mL/min(sccm), an O₂ gas partial pressure of about 5.53 Torr, and an O₂/Ru compound partial pressure ratio of about 22.12;

FIG. 9 shows an X-ray diffraction spectrum of a film formed while varying film forming temperatures to about 250° C., 270° C., 300° C. and 320° C. under the conditions including a pressure of about 50 Torr, an O₂ gas flow rate of about 100 mL/min(sccm), an Ru compound gas flow rate of about 2.26 mL/min(sccm), an O₂ gas partial pressure of about 9.96 Torr, and an O₂/Ru compound partial pressure ratio of about 44.25;

FIG. 10 shows X-ray diffraction spectra of films formed while varying film forming temperatures to about 270° C., 300° C. and 320° C. under the conditions including a pressure of about 20 Torr, an O₂ gas flow rate of about 50 mL/min(sccm), an Ru compound gas flow rate of about 5.71 mL/min(sccm), an O₂ gas partial pressure of about 2.19 Torr, and an O₂/Ru compound partial pressure ratio of about 8.76;

FIG. 11 shows X-ray diffraction spectra of films formed while varying film forming temperatures to about 270° C., 300° C. and 320° C. under the conditions including a pressure of about 20 Torr, an O₂ gas flow rate of about 100 mL/min(sccm), an Ru compound gas flow rate of about 5.71 mL/min(sccm), an O₂ gas partial pressure of about 3.95 Torr, and an O₂/Ru compound partial pressure ratio of about 17.51;

FIG. 12 shows relationship between a film formation time and a root-mean-square (RMS) roughness of a film and relationship between a film formation time and a film thickness in the case of forming a ruthenium oxide film by a CVD method under the conditions of the present invention;

FIG. 13 shows an X-ray diffraction spectrum of a film formed by a CVD method under the conditions of the present invention;

FIG. 14A shows an XPS spectrum of a film formed by a CVD method under the conditions of the present invention and FIG. 14B shows a result obtained by examining a film composition ratio by XPS;

FIG. 15 is a cross section showing shapes of holes when forming a ruthenium oxide film by a CVD method under the conditions of the present invention and a scanning electron microscope (SEM) image of the cross section of the hole;

FIG. 16 shows relationship between the number of cycles and a film thickness and relationship between the number of cycles and a root square value (RMS) roughness of a ruthenium oxide film formed by an ALD method under the conditions of the present invention;

FIG. 17 shows an X-ray diffraction spectrum of a film formed by an ALD method under the conditions of the present invention;

FIG. 18A shows an XPS spectrum of a film formed by an ALD method under the conditions of the present invention and FIG. 18B shows a result obtained by examining a film composition ratio by XPS; and

FIG. 19 is a cross section showing shapes of holes when forming a ruthenium oxide film by an ALD method under the conditions of the present invention and a scanning electron microscope (SEM) image of the cross section of the hole.

### DETAILED DESCRIPTION OF THE EMBODIMENTS

Hereinafter, embodiments of the present invention will be described with reference to the accompanying drawings which form a part hereof.

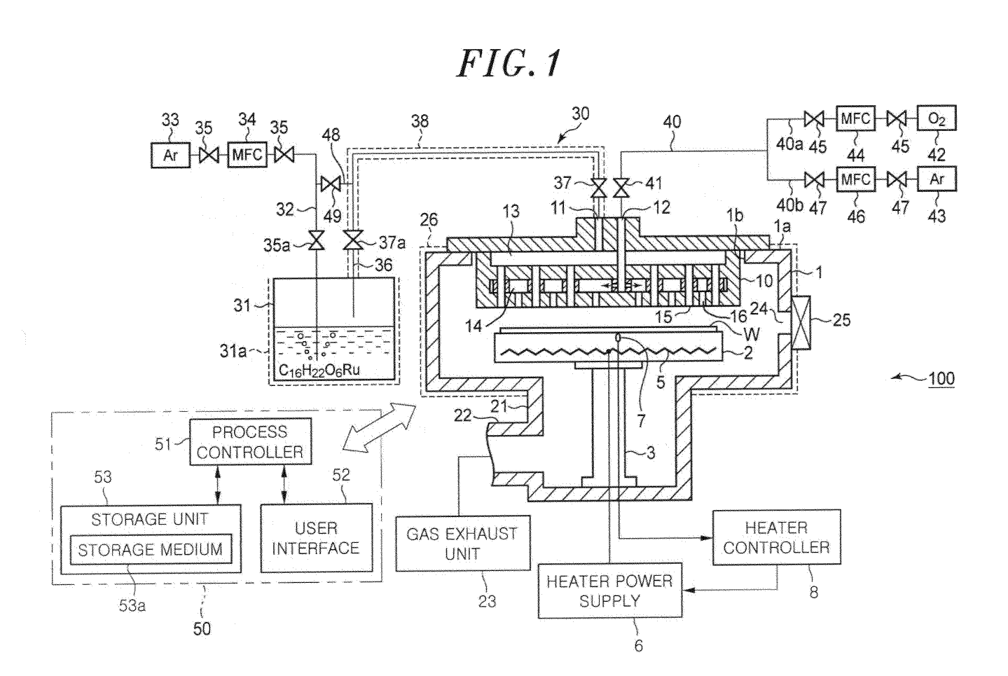

FIG. 1 is a schematic diagram showing an example of a film forming apparatus 100 for performing a method for forming a ruthenium oxide film in accordance with an embodiment of the present invention.

A film forming apparatus 100 includes a substantially cylindrical chamber 1 which is airtightly sealed. In the chamber 1, a susceptor 2 for horizontally supporting a wafer W as a substrate to be processed is supported by a cylindrical supporting member 3 extending from a bottom portion of a gas exhaust chamber 21 to be described later to a central bottom portion of the chamber 1. The susceptor 2 is made of ceramic such as AlN or the like. Further, a heater 5 is buried in the susceptor 2, and a heater power supply 6 is connected to the heater 5.

Meanwhile, a thermocouple 7 is provided near a top surface of the susceptor 2, and a signal from the thermocouple 7 is transmitted to a heater controller 8. Moreover, the heater controller 8 transmits an instruction to the heater power supply 6 in accordance with the signal from the thermocouple 7, and the wafer W is controlled to a predetermined temperature by controlling heating of the heater 5. Furthermore, three wafer elevation pins (not shown) are provided at the susceptor 2 so as to protrude from and retreat into the surface of the susceptor 2. When the wafer W is transferred, the elevation pins protrude from the surface of the susceptor 2.

A circular opening 1b is formed in a ceiling wall 1a of the chamber 1, and a shower head 10 is inserted thereinto so as to protrude into the chamber 1. The shower head 10 injects a film forming gas supplied from a gas supply unit 30 to be described later into the chamber 1. A first inlet line 11 through which the film forming gas is introduced and a second inlet line 12 through which a dilution gas (e.g., Ar gas) and oxygen gas (O₂ gas) as a reduction gas are introduced into the chamber 1 are provided at an upper portion of the shower head 10.

The space in the shower head 10 is partitioned into an upper space 13 and a lower space 14. The upper space 13 is connected to the first inlet line 11, and a first gas discharge path 15 extends from the space 13 to the bottom surface of the shower head 10. The lower space 14 is connected to the second inlet line 12, and a second gas discharge path 16 extends from the space 14 to the bottom surface of the shower head 10. In other words, the shower head 10 is configured to discharge the film forming gas and the oxygen gas from the gas discharge paths 15 and 16 separately.

A gas exhaust chamber 21 is provided at the bottom wall of the chamber 1 so as to protrude downward. A gas exhaust line 22 is connected to a side surface of the gas exhaust chamber 21, and a gas exhaust unit 23 having a vacuum pump, a pressure control valve or the like is connected to the gas exhaust line 22. Further, the pressure in the chamber 1 can be decreased to a predetermined level by controlling an opening degree of a pressure control valve (not shown) that operates the gas exhaust unit 23.

Provided on a sidewall of the chamber 1 are a loading/unloading port 24 through which a wafer W is loaded and unloaded and a gate valve 25 for opening and closing the loading/unloading port 24. Further, a heater 26 is provided at a wall of the chamber 1, so that a temperature of an inner wall of the chamber 1 can be controlled during film formation.

A gas supply unit 30 has a film forming material tank for reserving a ruthenium compound as a film forming source (precursor) having a structure of the following formula (1) in which two β-diketons and two groups selected from olefin, amine, nitril and carbonyl are coordinate-bonded to Ru. A heater 31a is provided around the film forming material tank 31 to heat a film forming material in the film forming material tank 31 to a proper temperature.

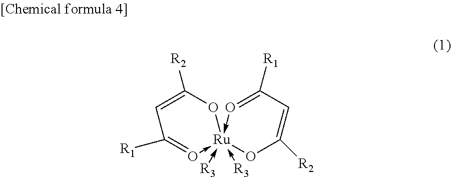

Here, R₁ and R₂ indicate alkyl groups having a total carbon number of 2 to 5, and R₃ indicates a group selected among olefin, amine, nitril and carbonyl.

In the film forming material tank 31, a bubbling line 32 for supplying Ar gas as a bubbling gas from above is inserted so as to be immersed in the film forming material. The bubbling line 32 is connected to the Ar gas supply source 33, and a mass flow controller 34 as a flow rate controller and a valve 35 disposed at an upstream side and a downstream side thereof are disposed on the bubbling line 32. Further, a source gas discharge line 36 is inserted from above into the film forming material tank 31, and the other end of the source gas discharge line 36 is connected to the first inlet line 11 of the shower head 10. A valve 37 is disposed on the source gas discharge line 36. Further, the source gas discharge line 36 is provided with a heater 38 for preventing condensation of the film forming material gas. The film forming material is vaporized by bubbling in the film forming material tank 31 by supplying Ar gas as a bubbling gas to the film forming material in the film forming material tank 31, and the formed film forming material gas is supplied into the shower head 10 via the source gas discharge line 36 and the first inlet line 11.

The bubbling line 32 and the source gas discharge line 36 are connected by a bypass line 48, and a valve 49 is disposed in the bypass line 48. Valves 35a and 37a are respectively disposed closer to the film forming material tank 31 than the connecting portion of the bypass line 48 in the bubbling line 32 and the source gas discharge line 36. By closing the valves 35a and 37a and opening the valve 49, Ar gas from the Ar gas supply source 33 may be supplied as a purge gas or the like into the chamber 1 via the bubbling line 32, the bypass line 48, and the source gas discharge line 36.

As for the bubbling gas or the purge gas, another inactive gas such as N₂ gas or the like may be used instead of Ar gas.

The second inlet line 12 of the shower head 10 is connected to a reduction gas supply line 40, and a valve 41 is disposed in the reduction gas supply line 40. The reduction gas supply line 40 is branched into branch lines 40a and 40b. The branch line 40a is connected to an O₂ gas supply source 42 for supplying an oxygen gas (O₂ gas), and the branch line 40b is connected to Ar gas supply source 43 for supplying Ar gas as a dilution gas or a purge gas. A mass flow controller 44 as a flow rate controller and valves 45 disposed provided at an upstream and a downstream side thereof are disposed on the branch line 40a. A mass flow controller 46 as a flow rate controller and valves 47 disposed provided at an upstream and a downstream side thereof are disposed on the branch line 40b. Further, as for a dilution gas or a purge gas, another inactive gas such as N₂ gas or the like may be used instead of Ar gas.

The film forming apparatus 100 includes a control unit 50 which is configured to control each component, i.e., valves, power supplies, heaters, pumps and the like. The control unit 50 has a process controller 51 having a micro processor (computer); a user interface 52 and a storage unit 53. Each component of the film forming apparatus 100 is electrically connected to and controlled by the process controller 51. The user interface 52 is connected to the process controller 51, and includes a keyboard through which an operator performs, e.g., an input operation in accordance with commands in order to manage each component of the film forming apparatus 100; a display for visually displaying an operational status of each component of the film forming apparatus 100; and the like. Further, the storage unit 53 is connected to the process controller 51 and stores control programs for performing various processes in the film forming apparatus 100 under the control of the process controller 51 or control program, i.e., processing recipes or various database, for performing a predetermined process in each component of the film forming apparatus 100 in accordance with the processing conditions. The processing recipes are stored in the storage medium 53a of the storage unit 53. The storage medium 53a may be a fixed medium such as a hard disk or the like, or may be a portable medium such as a CD-ROM, a DVD, a flash memory or the like. Alternatively, the recipe may be transmitted from a separate device through, e.g., a dedicated line.

If necessary, a predetermined processing recipe is retrieved from the storage unit 53 in accordance with instructions inputted through the user interface 52 and executed by the process controller 51. Accordingly, a desired process is performed in the film forming apparatus 100 under the control of the process controller 51.

Hereinafter, a method for forming a ruthenium oxide film in accordance with an embodiment of the present invention which is performed by the above-described film forming apparatus 100 will be described.

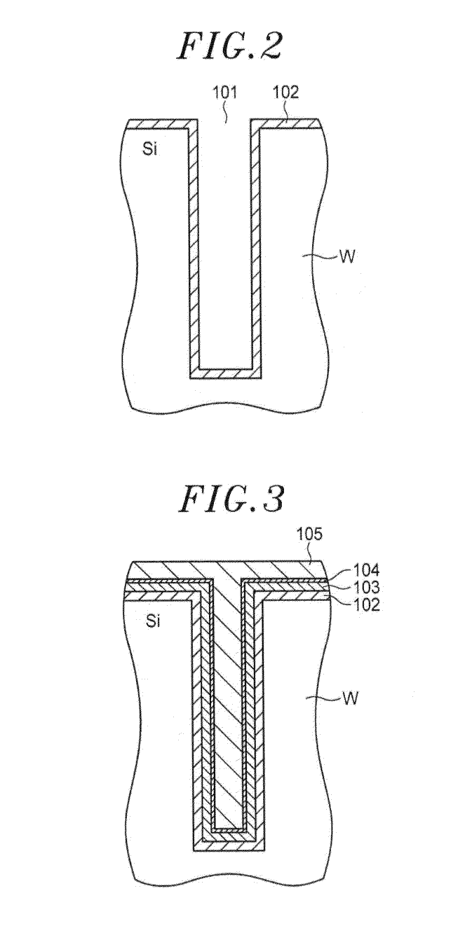

First, the gate valve 25 opens, and a wafer W is loaded into the chamber 1 via the loading/unloading port 24 by a transfer unit (not shown) and mounted on the susceptor 2. In the case of using a ruthenium oxide (RuOₓ) film as a lower electrode of a DRAM capacitor, there is used a wafer W (silicon substrate) having a trench 101 in which an RuOₓ film is formed as a lower electrode 102 as shown in FIG. 2. In the case of using a RuOₓ film as an upper electrode of a DRAM capacitor, there is used a wafer W (silicon substrate) having a trench 101 in which a lower electrode 102 and a dielectric film 103 formed of, e.g., an SiTiO film, are formed as shown in FIG. 3. Further, a barrier film 104 formed of, e.g., a TiN film, is formed on the dielectric film 103, and a RuOₓ film is formed as an upper electrode 105 on the barrier film 104.

Next, the pressure in the processing chamber 1 is set to a predetermined level by exhausting the chamber 1 by the gas exhaust unit 23, and the susceptor 2 is heated to a film forming temperature, preferably a predetermined temperature of about 200° C. to 350° C. Ar gas is supplied as a carrier gas at a predetermined flow rate from a bubbling line 32 to the film forming material tank 31 heated to, e.g., about 80° C. to 200° C., by the heater 31a. A ruthenium compound having a structure of a formula (1) in which two β-diketons and two groups selected from olefin, amine, nitril and carbonyl are coordinate-bonded to Ru is vaporized by bubbling and supplied as a film forming material into the chamber 1 via the source gas discharge line 36, the first inlet line 11, and the shower head 10. O₂ gas as a reduction gas is supplied into the chamber 1 from the O₂ gas supply source 42 via the branch line 40a, the reduction gas supply line 40, the second inlet line 12, and the shower head 10.

The ruthenium compound gas having the structure of the formula (1) and the O₂ gas as the reduction gas are supplied into the chamber 1 and react on the surface of the wafer W heated by the susceptor 2. Therefore, an RuOₓ film is formed on the wafer W by thermal CVD. The ruthenium compound of the formula (1) is in a liquid state at a room temperature and has a comparatively low vapor pressure. Hence, it is easily supplied in a gas phase.

At this time, the pressure in the chamber 1 is preferably about 5 Torr to 100 Torr (about 665 Pa to 13330 Pa); the flow rate of the carrier gas is preferably about 100 mL/min(sccm) to 500 mL/min(sccm) (corresponding to ruthenium compound of about 0.5 mL/min(sccm) to 14.6 mL/min(sccm)); and the flow rate of O₂ gas as a reduction gas is preferably about 25 mL/min(sccm) to 500 mL/min(sccm).

In U.S. Pat. No. 7,049,232, a ruthenium film is formed by a ruthenium compound of the formula (1) and O₂ gas. However, it was first found in the present invention that the ruthenium oxide (RuOₓ) film can be formed by controlling the amount of O₂ gas used as a reduction gas. In other words, it was found that a RuOₓ film can be formed by reducing the compound gas and supplying O₂ gas at a flow rate that allows the reduced Ru to be oxidized. Moreover, in order to reliably form a RuOₓ film, it is preferable to control an O₂ gas partial pressure in the chamber 1 or an O₂ gas/Ru compound gas partial pressure ratio. The O₂ gas partial pressure in the chamber 1 is preferably about 5 Torr (665 Pa) or above, and the O₂ gas/Ru compound gas partial pressure ratio is preferably about 20 or above.

In the ruthenium compound, any one of 2,4-hexanedione, 5-methyl-2,4-hexanedione, 2,4-heptanedione, 5-methyl-2,4-heptanedione, 6-methyl-2,4-heptanedione or 2,4-octanedione may be used as the β-diketone.

In the ruthenium compound having the structure of the formula (1), the ruthenium compound preferably has the structure of the following formula (2) in which R₃ is carbonyl.

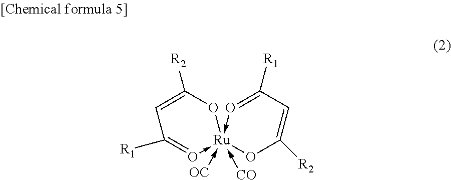

Such a ruthenium compound, for example, may be a compound having a structure of the following formula (3) whose empirical formula is C₁₆H₂₂O₆Ru.

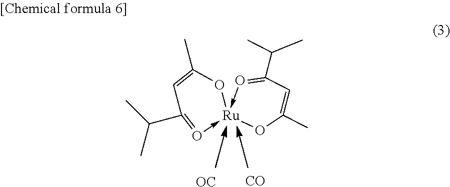

In the case of using the compound having the structure of the formula (3), it is considered that ruthenium oxide is formed by the following reaction stoichiometrically.

2C₁₆H₂₂O₆Ru+39O_{2→}2RuO₂+22H₂O_{↑}+32CO_{2↑}

The Ru compound having the structure of the formula (3) has three types of isomers in which the positions of the methyl groups and propyl groups of the two p-diketons are different. However, the content ratio of the isomers may vary.

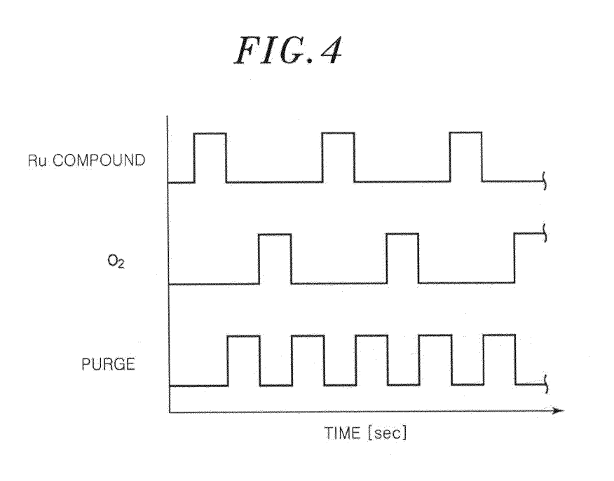

In the case of forming a RuOₓ film, there may be used an ALD method in which a ruthenium compound gas and O₂ gas as a reduction gas are alternately supplied with a purge process therebetween as shown in FIG. 4, instead of a method in which the ruthenium compound gas and the O₂ gas are simultaneously supplied as described above. Ar gas supplied form the Ar gas supply source 43 may be used for the purge process. Ar gas may be supplied from the Ar gas supply source 33 via the bubbling line 32, the bypass line 48 and the source gas discharge line 36. Or, both routes may be used. By using the ALD method, a RuOₓ film having a smaller amount of impurities may be formed at a lower film forming temperature.

After the RuOₓ film is formed as described above, the supply of the Ru compound gas and the O₂ gas was stopped. At the same time, the chamber 1 is purged by supplying Ar gas into the chamber 1 from the Ar gas supply sources 43 and 33 without stopping operation of the vacuum pump of the gas exhaust unit 23. Upon completion of the purge process, the gate valve 25 opens, and the wafer W is unloaded through the loading/unloading port 24 by a transfer unit (not shown). Accordingly, a film forming process for a single wafer W is completed.

In the present embodiment, the RuOₓ film is formed by a CVD method (including an ALD method) using a ruthenium compound having a structure of the formula (1) in which two β-diketons and two groups selected from olefin, amine, nitril and carbonyl are coordinate-bonded to Ru as a film forming material and O₂ gas as a reduction gas while controlling the flow rates thereof. As a consequence, the film formation can be performed while ensuring a short incubation time and a high film forming rate, and a good step coverage that allows a film to be formed in a recess having a high aspect ratio of about 50 or above can be achieved. In other words, in the ruthenium compound having a structure of the formula (1), groups (ligands) such as olefin, amine, nitril, carbonyl or the like which are coordinate-bonded to Ru are difficult to prevent Ru from being adsorbed onto the substrate and comparatively easily separated, so that Ru is easily adsorbed onto the substrate, which results in a short incubation time. Since Ru is easily adsorbed onto the substrate, an excellent step coverage can be obtained, and a film can be formed in a recess having a high aspect ratio of about 50 or above. Moreover, other β-diketons (diketonate ligands) are easily composed by the O₂ gas. Hence, a RuOₓ film can be rapidly formed on the substrate, and a high film forming rate can be obtained.

Particularly, in the compound having the formula (1), if the compound has a structure of the formula (2) in which R₃ is carbonyl (CO), the carbonyl having a small molecular weight does not disturb adsorption of Ru onto the wafer W. Further, in the group of R₃, carbonyl is especially easily separated from the compound. Thus Ru can be easily adsorbed onto the wafer W. Hence, the effect in which the incubation time is reduced and the step coverage is increased is further effectively realized.

Hereinafter, the test result of the present invention will be described.

Here, as for a Ru compound, one having a structure of a formula (3) was used, and a flow rate of Ar gas as a carrier gas for bubbling the Ru compound was fixed to about 400 mL/min(sccm). Further, a flow rate of O₂ gas was varied to about 5 mL/min(sccm), 10 mL/min(sccm), 20 mL/min(sccm), 50 mL/min(sccm) and 100 mL/min(sccm); a pressure in the chamber 1 was varied to about 50 Torr (6666.12 Pa) and 20 Torr (2666.45 Pa); at the pressure of about 50 Torr and each of the aforementioned O₂ gas flow rates, a film forming temperature was varied to about 250° C., 270° C., 300° C. and 320° C.; at the pressure of about 20 Torr and each of the aforementioned O₂ gas flow rates, a film forming temperature was varied to about 270° C., 300° C. and 320° C. In that state, the film formation was performed, and a crystal structure of the film was examined by X-ray diffraction (XRD). At this time, the flow rate of the Ru compound was about 5.71 mL/min(sccm) at about 20 Torr and about 2.26 mL/min(sccm) at about 50 Torr. Moreover, the O₂ gas partial pressure, the Ru compound gas partial pressure and the O₂ gas partial pressure/Ru compound gas partial pressure (hereinafter, referred to as “O₂/Ru compound partial pressure ratio”) were calculated from the pressure in the chamber, the O₂ gas flow rate, the Ru compound gas flow rate.

Table 1 shows a pressure in the chamber, an O₂ gas flow rate, a Ru compound gas flow rate, Ar gas flow rate, an O₂ gas partial pressure, a Ru compound gas partial pressure, and an O₂/Ru compound partial pressure ratio in this test.

Table 2 shows O₂ gas partial pressures and film crystal structures which were monitored by XRD at a pressure of about 50 Torr while varying O₂ gas flow rates and film forming temperatures. Table 3 shows O₂ gas partial pressures and film crystal structures which were monitored by XRD at a pressure of about 20 Torr while varying O₂ gas flow rates and film forming temperatures. Table 4 shows O₂/Ru compound partial pressure ratios and film crystal structures which were monitored by XRD at a pressure of about 50 Torr while varying O₂ gas flow rates and film forming temperatures. Table 5 shows O₂/Ru compound partial pressure ratios and film crystal structures which were monitored by XRD at a pressure of about 20 Torr while varying O₂ gas flow rates and film forming temperatures. Table 6 shows O₂ gas partial pressures and film crystal structures which were monitored by XRD at different film forming temperatures. Table 7 shows O₂/Ru compound gas partial pressure ratios and film crystal structures which were monitored by XRD at different film forming temperatures. In Tables 2 to 7, ┌Ru┘ indicates that Ru crystal has been monitored, and ┌RuO₂┘ indicates that RuO₂ crystal has been monitored.

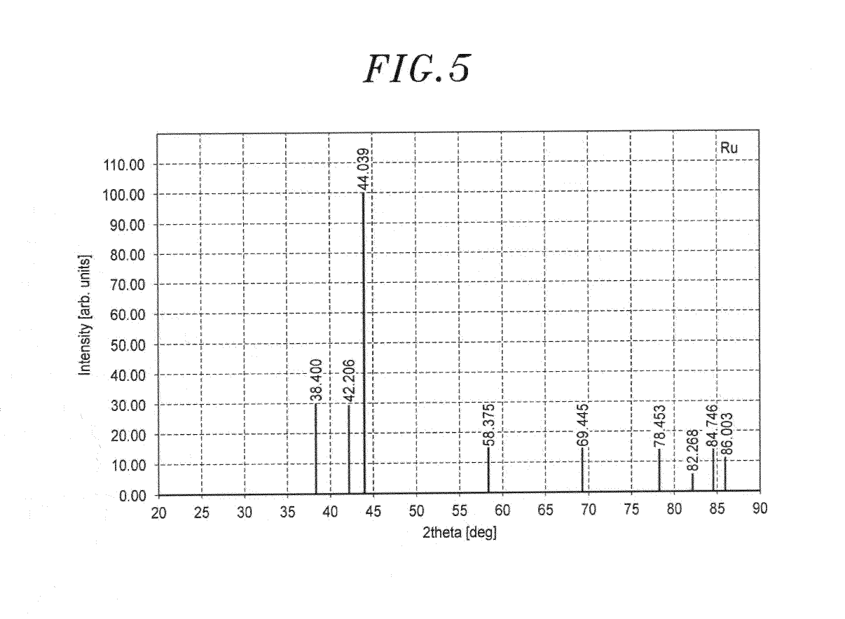

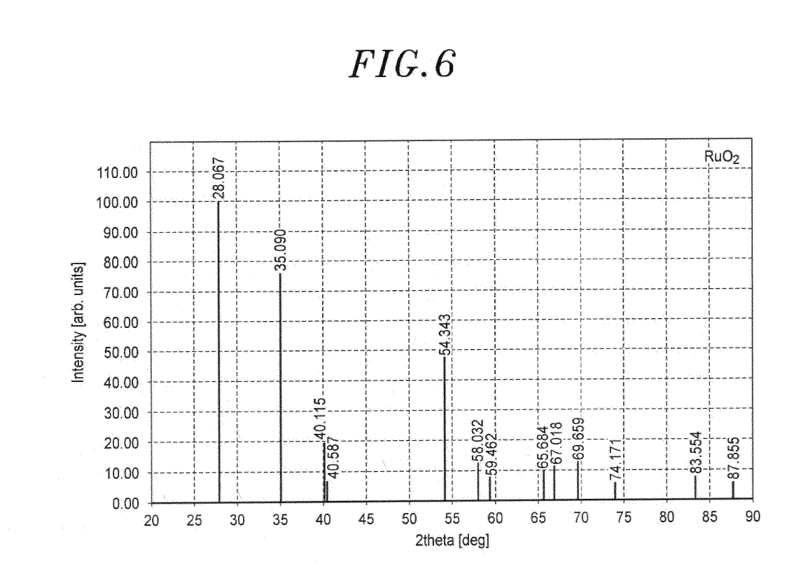

The monitoring of the crystal structures by the XRD was performed by comparing a chart showing a diffraction peak of Ru shown in FIG. 5, a chart showing a diffraction peak of RuO₂ shown in FIG. 6, and an X-ray diffraction spectrum obtained by performing X-ray diffraction on each film.

As illustrated in Tables 2 to 7, a RuO₂ film is formed under predetermined conditions. Further, whether the film is Ru or RuO₂ depends on an O₂ gas partial pressure or an O₂/Ru compound partial pressure ratio without depending on a film forming temperature. It was clear that a RuO₂ film was formed when an O₂ gas partial pressure was about 5 Torr or above and an O₂/Ru compound partial pressure ratio was about 20 or above.

TABLE 1

| | | Ru | | Ru | | O₂/Ru |
|---|---|---|---|---|---|---|
| | | compound | | compound | O₂ gas | compound |
| | O₂ gas | gas flow | Ar gas | gas partial | partial | partial |
| | flow rate | rate | flow rate | pressure | pressure | pressure |
| | (mL/min) | (mL/min) | (mL/min) | (Torr) | (Torr) | ratio |
| 50 Torr | 100.00 | 2.26 | 400 | 0.22 | 9.96 | 44.25 |
| | 50.00 | 2.26 | 400 | 0.25 | 5.53 | 22.12 |
| | 20.00 | 2.26 | 400 | 0.27 | 2.37 | 8.85 |
| | 10.00 | 2.26 | 400 | 0.27 | 1.21 | 4.42 |
| | 5.00 | 2.26 | 400 | 0.28 | 0.61 | 2.21 |
| 20 Torr | 100.00 | 5.71 | 400 | 0.23 | 3.95 | 17.51 |
| | 50.00 | 5.71 | 400 | 0.25 | 2.19 | 8.76 |
| | 20.00 | 5.71 | 400 | 0.27 | 0.94 | 3.50 |
| | 10.00 | 5.71 | 400 | 0.27 | 0.48 | 1.75 |
| | 5.00 | 5.71 | 400 | 0.28 | 0.24 | 0.88 |

TABLE 2

| | O₂ gas partial pressure (Torr) and identification | | | | |
|---|---|---|---|---|---|
| | of crystal structure by XRD | | | | |
| | O₂ gas | O₂ gas | O₂ gas | O₂ gas | O₂ gas |
| | flow rate | flow rate | flow rate | flow rate | flow rate |
| 50 Torr | 5 mL/min | 10 mL/min | 20 mL/min | 50 mL/min | 100 mL/min |
| 250° C. | 0.61 | 1.21 | 2.37 | 5.53 | 9.96 |
| | (Ru) | (Ru) | (Ru) | (RuO₂) | (RuO₂) |
| 270° C. | 0.61 | 1.21 | 2.37 | 5.53 | 9.96 |
| | (Ru) | (Ru) | (Ru) | (RuO₂) | (RuO₂) |
| 300° C. | 0.61 | 1.21 | 2.37 | 5.53 | 9.96 |
| | (Ru) | (Ru) | (Ru) | (RuO₂) | (RuO₂) |
| 320° C. | 0.61 | 1.21 | 2.37 | 5.53 | 9.96 |
| | (Ru) | (Ru) | (Ru) | (RuO₂) | (RuO₂) |

TABLE 3

| | O₂ gas partial pressure (Torr) and identification | | | | |
|---|---|---|---|---|---|
| | of crystal structure by XRD | | | | |
| | O₂ gas | O₂ gas | O₂ gas | O₂ gas | O₂ gas |
| | flow rate | flow rate | flow rate | flow rate | flow rate |
| 20 Torr | 5 mL/min | 10 mL/min | 20 mL/min | 50 mL/min | 100 mL/min |
| 270° C. | 0.24 | 0.48 | 0.94 | 2.19 | 3.95 |
| | (Ru) | (Ru) | (Ru) | (Ru) | (Ru) |
| 300° C. | 0.24 | 0.48 | 0.94 | 2.19 | 3.95 |
| | (Ru) | (Ru) | (Ru) | (Ru) | (Ru) |
| 320° C. | 0.24 | 0.48 | 0.94 | 2.19 | 3.95 |
| | (Ru) | (Ru) | (Ru) | (Ru) | (Ru) |

TABLE 4

| | O₂/Ru compound partial pressure ratio and | | | | |
|---|---|---|---|---|---|
| | identification of crystal structure by XRD | | | | |
| | O₂ gas | O₂ gas | O₂ gas | O₂ gas | O₂ gas |
| | flow rate | flow rate | flow rate | flow rate | flow rate |
| 50 Torr | 5 mL/min | 10 mL/min | 20 mL/min | 50 mL/min | 100 mL/min |
| 250° C. | 2.21 | 4.42 | 8.85 | 22.12 | 44.25 |
| | (Ru) | (Ru) | (Ru) | (RuO₂) | (RuO₂) |
| 270° C. | 2.21 | 4.42 | 8.85 | 22.12 | 44.25 |
| | (Ru) | (Ru) | (Ru) | (RuO₂) | (RuO₂) |
| 300° C. | 2.21 | 4.42 | 8.85 | 22.12 | 44.25 |
| | (Ru) | (Ru) | (Ru) | (RuO₂) | (RuO₂) |
| 320° C. | 2.21 | 4.42 | 8.85 | 22.12 | 44.25 |
| | (Ru) | (Ru) | (Ru) | (RuO₂) | (RuO₂) |

TABLE 5

| | O₂/Ru compound partial pressure ratio and | | | | |
|---|---|---|---|---|---|
| | identification of crystal structure by XRD | | | | |
| | O₂ gas | O₂ gas | O₂ gas | O₂ gas | O₂ gas |
| | flow rate | flow rate | flow rate | flow rate | flow rate |
| 20 Torr | 5 mL/min | 10 mL/min | 20 mL/min | 50 mL/min | 100 mL/min |
| 270° C. | 0.88 | 1.75 | 3.50 | 8.76 | 17.51 |
| | (Ru) | (Ru) | (Ru) | (Ru) | (Ru) |
| 300° C. | 0.88 | 1.75 | 3.50 | 8.76 | 17.51 |
| | (Ru) | (Ru) | (Ru) | (Ru) | (Ru) |
| 320° C. | 0.88 | 1.75 | 3.50 | 8.76 | 17.51 |
| | (Ru) | (Ru) | (Ru) | (Ru) | (Ru) |

TABLE 6

| 20 Torr + | O₂ gas partial pressure (Torr) and identification of | | | | | | | | | |
|---|---|---|---|---|---|---|---|---|---|---|
| 50 Torr | crystal structure by XRD | | | | | | | | | |
| 250° C. | — | — | 0.61 | — | 1.21 | — | 2.37 | — | 5.53 | 9.96 |
| | | | (Ru) | | (Ru) | | (Ru) | | (RuO₂) | (RuO₂) |
| 270° C. | 0.24 | 0.48 | 0.61 | 0.94 | 1.21 | 2.19 | 2.37 | 3.95 | 5.53 | 9.96 |
| | (Ru) | (Ru) | (Ru) | (Ru) | (Ru) | (Ru) | (Ru) | (Ru) | (RuO₂) | (RuO₂) |
| 300° C. | 0.24 | 0.48 | 0.61 | 0.94 | 1.21 | 2.19 | 2.37 | 3.95 | 5.53 | 9.96 |
| | (Ru) | (Ru) | (Ru) | (Ru) | (Ru) | (Ru) | (Ru) | (Ru) | (RuO₂) | (RuO₂) |
| 320° C. | 0.24 | 0.48 | 0.61 | 0.94 | 1.21 | 2.19 | 2.37 | 3.95 | 5.53 | 9.96 |
| | (Ru) | (Ru) | (Ru) | (Ru) | (Ru) | (Ru) | (Ru) | (Ru) | (RuO₂) | (RuO₂) |

TABLE 7

| 20 Torr + | O₂/Ru compound partial pressure ratio and identification of | | | | | | | | | |
|---|---|---|---|---|---|---|---|---|---|---|
| 50 Torr | crystal structure by XRD | | | | | | | | | |
| 250° C. | — | — | 2.21 | — | 4.42 | — | 8.85 | — | 22.12 | 44.25 |
| | | | (Ru) | | (Ru) | | (Ru) | | (RuO₂) | (RuO₂) |
| 270° C. | 0.88 | 1.75 | 2.21 | 3.50 | 4.42 | 8.76 | 8.85 | 17.51 | 22.12 | 44.25 |
| | (Ru) | (Ru) | (Ru) | (Ru) | (Ru) | (Ru) | (Ru) | (Ru) | (RuO₂) | (RuO₂) |
| 300° C. | 0.88 | 1.75 | 2.21 | 3.50 | 4.42 | 8.76 | 8.85 | 17.51 | 22.12 | 44.25 |
| | (Ru) | (Ru) | (Ru) | (Ru) | (Ru) | (Ru) | (Ru) | (Ru) | (RuO₂) | (RuO₂) |
| 320° C. | 0.88 | 1.75 | 2.21 | 3.50 | 4.42 | 8.76 | 8.85 | 17.51 | 22.12 | 44.25 |
| | (Ru) | (Ru) | (Ru) | (Ru) | (Ru) | (Ru) | (Ru) | (Ru) | (RuO₂) | (RuO₂) |

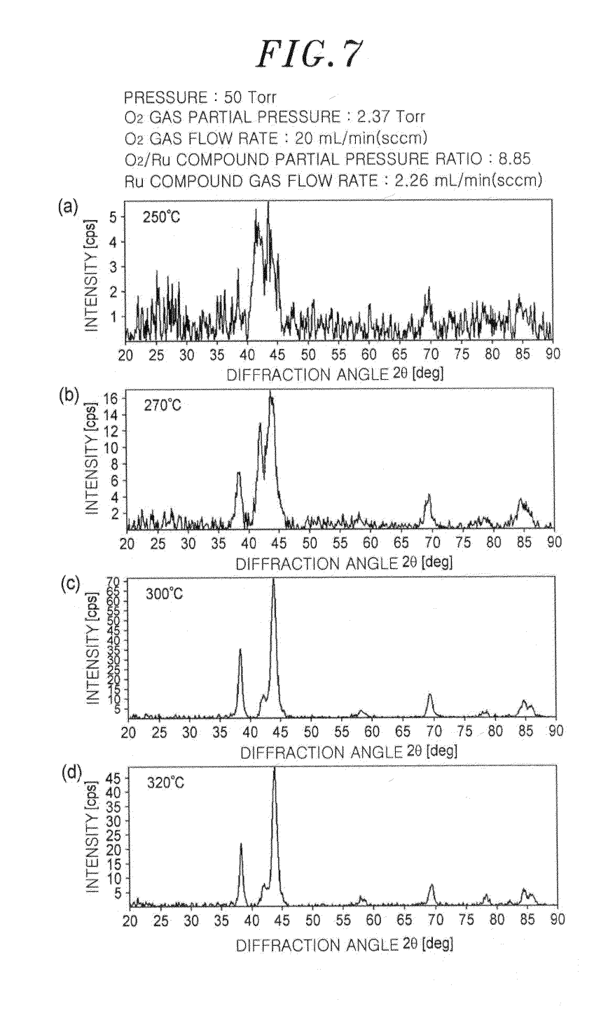

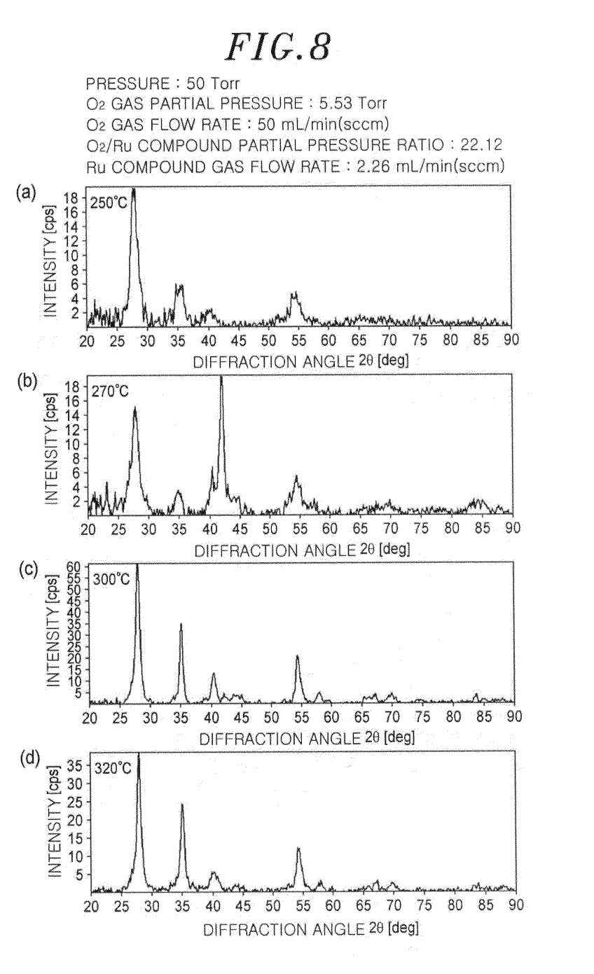

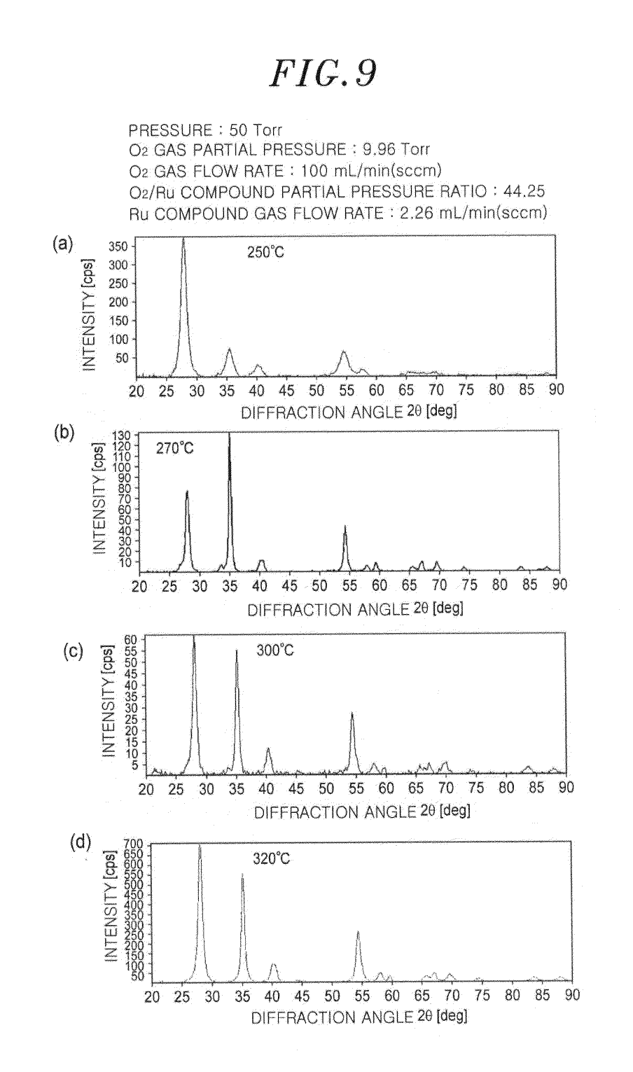

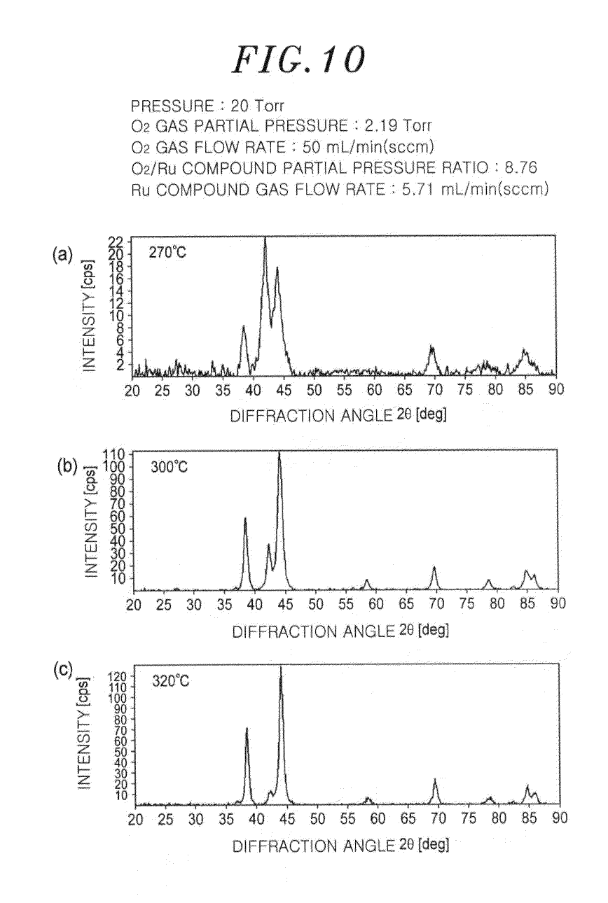

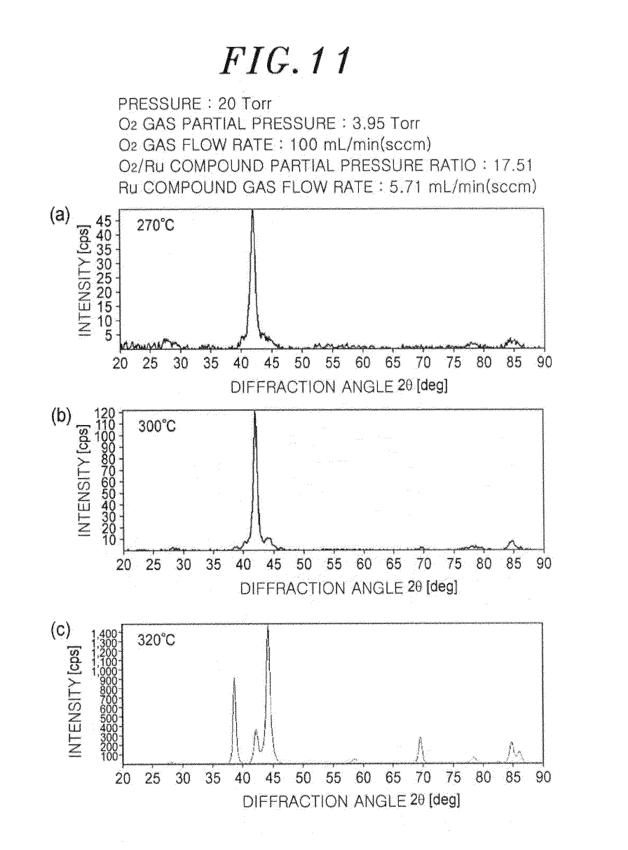

FIGS. 7 to 11 show examples of X-ray diffraction spectra obtained by actually performing X-ray diffraction on films. FIG. 7 shows X-ray diffraction spectra of films formed while varying a film forming temperature to about 250° C., 270° C., 300° C., 320° C. under the conditions including a pressure of about 50 Torr, an O₂ gas flow rate of about 20 mL/min(sccm), an Ru compound gas flow rate of about 2.26 mL/min(sccm), an O₂ gas partial pressure of about 2.37 Torr, and an O₂/Ru compound partial pressure ratio of about 8.85. FIG. 8 shows X-ray diffraction spectra of films formed while varying a film forming temperature to about 250° C., 270° C., 300° C., 320° C. under the conditions including a pressure of about 50 Torr, an O₂ gas flow rate of about 50 mL/min(sccm), an Ru compound gas flow rate of about 2.26 mL/min(sccm), an O₂ gas partial pressure of about 5.53 Torr, and an O₂/Ru compound partial pressure ratio of about 22.12. FIG. 9 shows X-ray diffraction spectra of films formed while varying a film forming temperature to about 250° C., 270° C., 300° C., 320° C. under the conditions including a pressure of about 50 Torr, an O₂ gas flow rate of about 100 mL/min(sccm), an Ru compound gas flow rate of about 2.26 mL/min(sccm), an O₂ gas partial pressure of about 9.96 Torr, and an O₂/Ru compound partial pressure ratio of about 44.25. FIG. 10 shows X-ray diffraction spectra of films formed while varying a film forming temperature to about 270° C., 300° C., 320° C. under the conditions including a pressure of about 20 Torr, an O₂ gas flow rate of about 50 mL/min(sccm), an Ru compound gas flow rate of about 5.71 mL/min(sccm), an O₂ gas partial pressure of about 2.19 Torr, and an O₂/Ru compound partial pressure ratio of about 8.76. FIG. 11 shows X-ray diffraction spectra of films formed while varying a film forming temperature to about 270° C., 300° C., 320° C. under the conditions including a pressure of about 20 Torr, an O₂ gas flow rate of about 100 mL/min(sccm), an Ru compound gas flow rate of about 5.71 mL/min(sccm), an O₂ gas partial pressure of about 3.95 Torr, and an O₂/Ru compound partial pressure ratio of about 17.51.

As illustrated in these X-ray diffraction spectra, an RuO₂ film was formed when an O₂ gas partial pressure was about 5 Torr or above an O₂/Ru compound partial pressure ratio was about 20 or above. When an O₂ gas partial pressure was smaller than about 5 Torr or an O₂/Ru compound partial pressure ratio was smaller than about 20, an Ru film was formed.

Next, an RuO₂ film was formed by CVD at about 250° C. while using a compound having a structure of the formula (3) as an Ru compound and setting a pressure to about 50 Torr, an O₂ gas flow rate to about 200 mL/min(sccm), and a flow rate of Ar gas as a carrier gas for bubbling an Ru compound to about 400 mL/min(sccm) (corresponding to an Ru compound flow rate of about 2.26 mL/min(sccm)). Under such conditions, an O₂ gas partial pressure was about 16.6 Torr, and an O₂/Ru compound partial pressure ratio was about 88.5.

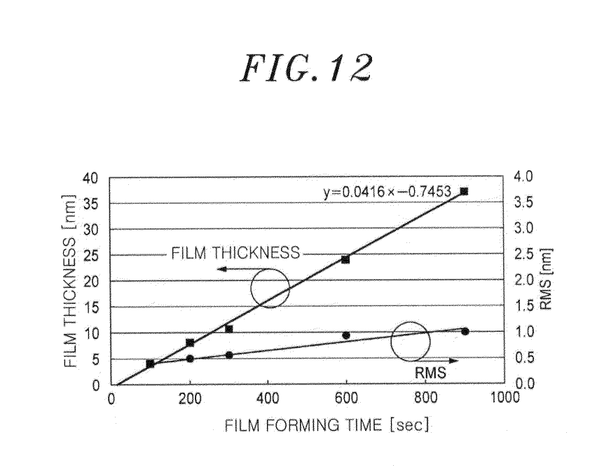

FIG. 12 shows relationship between a film forming time and a film thickness and that between a film forming time and a root-mean-square (RMS) of a film roughness. As shown in FIG. 12, a short incubation time of about 18 sec and a high film forming rate of about 2.5 nm/min were realized by using the Ru compound of the present invention. Moreover, in a practical film thickness of about 10.6 nm, a resistivity of about 215.9 μΩ/cm and an RMS of about 0.553 nm were obtained.

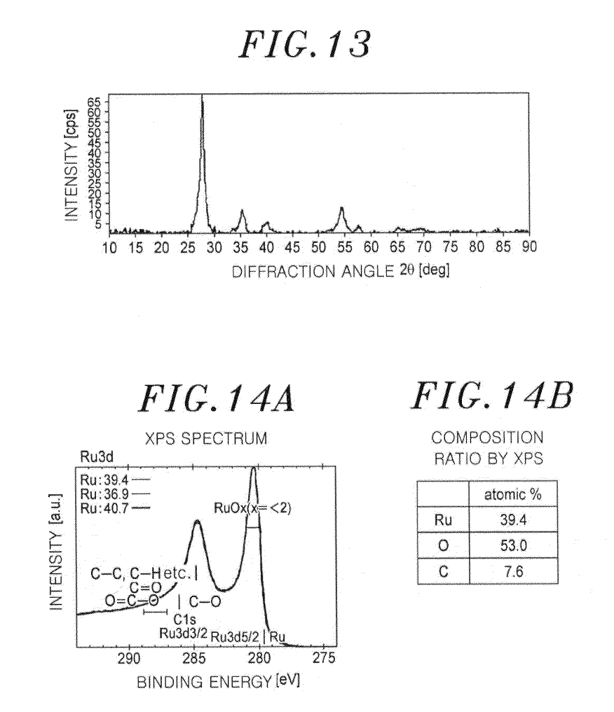

FIG. 13 shows an X-ray diffraction spectrum of an obtained film. In that case, a diffraction peak of RuO₂ was clearly seen, and an RuO₂ film was formed. FIG. 14A shows an X-ray photoelectron spectroscopy (XPS) spectrum of the obtained film and FIG. 14B shows a result of examining a composition ratio of a film by XPS. Referring to the XPS spectrum, Ru was mainly bonded to O. Further, it was seen from the composition ratio that RuO₂ film was formed.

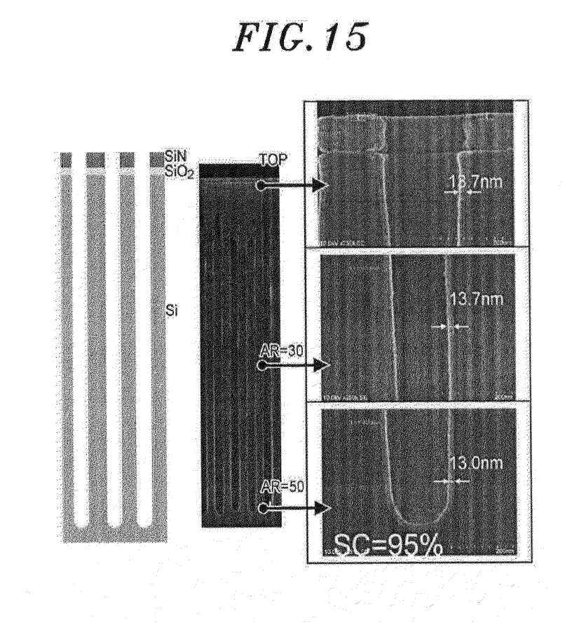

Next, a 300 mm Si wafer having a hole having a diameter of about 200 nm and a depth of about 10000 nm as shown in FIG. 15 was prepared, and an RuO₂ film was formed thereon by CVD under the above conditions. FIG. 15 shows an SEM image showing a cross section of the hole. A film thickness at a top portion was about 13.7 nm; a film thickness at a depth corresponding to an aspect ratio (AR) of about 30 was about 13.7 nm; and a film thickness at the vicinity of the bottom corresponding to an aspect ratio (AR) of about 50 was about 13.0 nm. Moreover, the step coverage (SC) was about 95%. In other words, an RuO₂ film can be formed in a recess having an aspect ratio of about 50 or above while ensuring a considerably high step coverage (SC).

Thereafter, an RuO₂ film was formed by ALD at about 220° C. while using a compound having a structure of the formula (3) as an Ru compound and setting a pressure to about 50 Torr, an O₂ gas flow rate to about 1000 mL/min(sccm), and a flow rate of Ar gas as a carrier gas for bubbling an Ru compound to about 400 mL/min(sccm) (corresponding to an Ru compound flow rate of about 2.26 mL/min(sccm)). Under such conditions, an O₂ gas partial pressure was about 50 Torr, and an O₂/Ru compound partial pressure ratio was about 177.9, which are the conditions that an RuO₂ film can be formed.

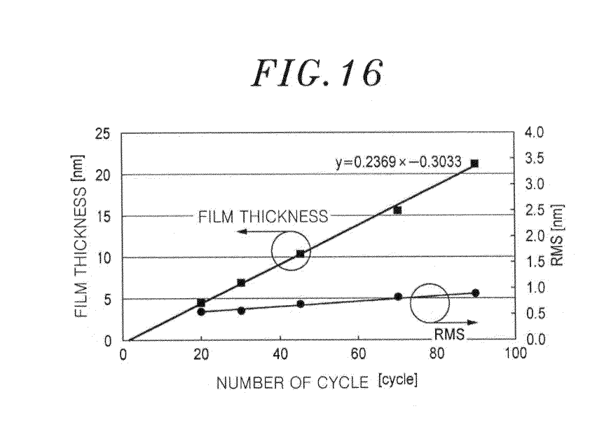

FIG. 16 shows relationship among the number of cycles, a film thickness and a root-mean-square (RMS) of a film roughness. As shown in FIG. 16, a short incubation time of about 1 cycle (about 135 sec) and a high cycle rate of about 0.24 nm/cycle were obtained by using the Ru compound of the present invention. Moreover, in a practical film thickness of about 10.5 nm, a resistivity of about 141 μΩ/cm and an RMS of about 0.698 nm were obtained.

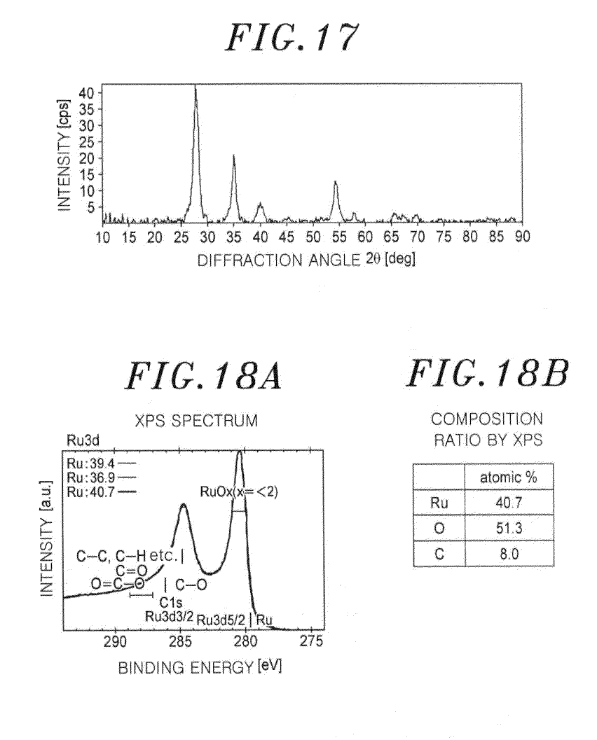

FIG. 17 shows an X-ray diffraction spectrum of an obtained film. In that case, a diffraction peak of RuO₂ was clearly seen, and an RuO₂ film was formed. FIG. 18A shows an X-ray photoelectron spectroscopy (XPS) spectrum of the obtained film and FIG. 18B shows a result of examining a composition ratio of a film by XPS. Referring to the XPS spectrum, Ru was mainly bonded to O. Further, it was seen from the composition ratio that RuO₂ film was formed.

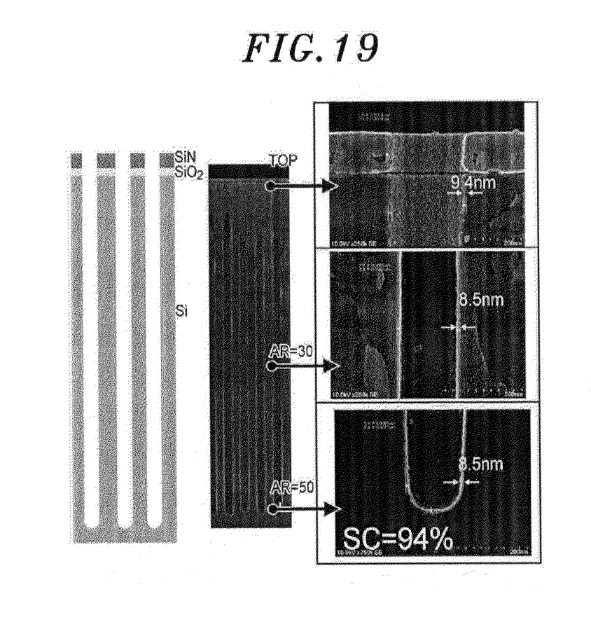

Then, a 300 mm Si wafer having a hole having a diameter of about 200 nm and a depth of about 10000 nm as shown in FIG. 19 was prepared, and an RuO₂ film was formed thereon by ALD under the above conditions. FIG. 19 shows an SEM image illustrating a cross section of a hole. A film thickness of a top portion was about 9.4 nm; a film thickness at a depth corresponding to an aspect ratio (AR) of about 30 was about 8.5 nm; and a film thickness at the vicinity of the bottom corresponding to an aspect ratio (AR) of about 50 was about 8.5 nm. Further, the step coverage (SC) was about 94%. In other words, an RuO₂ film can be formed in a recess having an aspect ratio of about 50 or above while ensuring a considerably high step coverage (SC).

The present invention may be variously modified without being limited to the above embodiment. For example, the above embodiment has described the test result of the compound having the formula (3). Since, however, the adsorptivity of Ru is the same regardless of the groups of R₁ and R₂ of the formula (2), the same effect as that of the compound expressed by the formula (2) can be obtained. Further, R₃ in the formula (1) is a group other than a carbonyl group and the adsorptivity of Ru is similar, so that the same effect as that of the compound expressed by the formula (1) can be obtained.

In the above-described embodiment, an RuOₓ film was applied for an upper or a lower electrode of an SrTiO film as a capacitor film. However, it may also be applied for an upper or a lower electrode of another capacitor film such as ZnO, Al₂O₃, ZrO or laminated films of ZnO and Al₂O₃, other than an SrTiO film. Further, it may also be applied for a conductive member such as a gate electrode, a contact barrier film or the like.

The structure of the film forming apparatus is not limited to that of the above-described embodiment. A method for supplying an Ru compound as a film forming material is not limited to bubbling of the above-described embodiment. The Ru compound as a film forming material may be supplied by a vaporizer or may be heated and supplied in a vapor state.

While the invention has been shown and described with respect to the embodiments, it will be understood by those skilled in the art that various changes and modification may be made without departing from the scope of the invention as defined in the following claims.

What is claimed is:

1. A method for forming a ruthenium oxide film, comprising:
providing a substrate in a processing chamber;
supplying a ruthenium compound having a structure of the following formula (1) in which two β-diketons and two groups selected among olefin, amine, nitril, and carbonyl are coordinate-bonded to Ru in a vapor state onto the substrate;
supplying oxygen gas onto the substrate; and
forming a ruthenium oxide film on the substrate by reaction between the ruthenium compound gas and the oxygen gas. 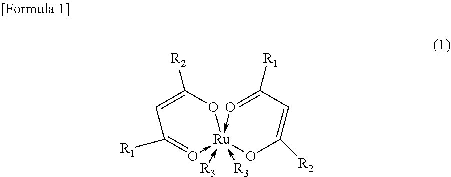
where R₁ and R₂ indicate alkyl groups having a total carbon number of about 2 to 5, and R₃ indicates a group selected among an olefin group, an amine group, a nitril group and a carbonyl group.

2. The method of claim 1, wherein the oxygen gas is supplied at a flow rate that allows the ruthenium compound to be reduced to metal ruthenium and the reduced metal ruthenium to be oxidized.

3. The method of claim 2, wherein the oxygen gas is supplied such that an oxygen gas partial pressure in the processing chamber becomes about 5 Torr or above.

4. The method of claim 2, wherein the ruthenium compound and the oxygen gas are supplied such that a partial pressure ratio of the oxygen gas to the Ru compound gas in the processing chamber becomes about 20 or above.

5. The method of claim 1, wherein the β-diketons of the ruthenium compound are any one of 2,4-hexanedione, 5-methyl-2,4-hexanedione, 2,4-heptanedione, 5-methyl-2,4-heptanedione, 6-methyl-2,4-heptanedione, and 2,4-octanedione.

6. The method of claim 1, wherein the ruthenium compound has a structure of the following formula (2) in which R₃ of the formula (1) is a carbonyl group:

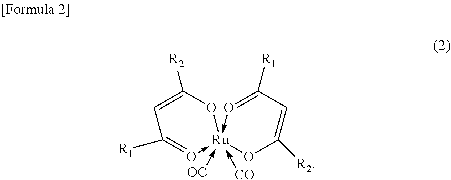

7. The method of claim 1, wherein the ruthenium compound has a structure of the following formula (3) whose empirical formula is C₁₆H₂₂O₆Ru:

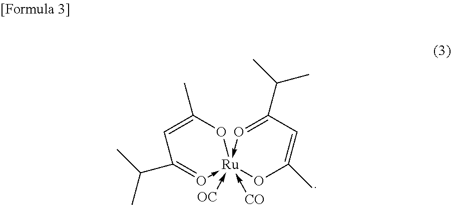

8. The method of claim 1, wherein the ruthenium compound gas and the oxygen gas are simultaneously supplied into the processing chamber.

9. The method of claim 1, wherein the ruthenium compound gas and the oxygen gas are alternately supplied into the processing chamber with a purge process therebetween.

10. A storage medium that stores a program for execution on a computer to control a film forming apparatus, wherein the program, when executed, controls the film forming apparatus such that the method of claim 1 is performed.
